(19) United States
(12) Patent Application Publication
(10) Pub. No.: US 2014/0358440 A1
(43) Pub. Date: Dec. 4, 2014

(54) System and Method For Characterizing Geological Systems Using Statistical Methodologies

(71) Applicants: Michael Pyrcz, The Woodlands, TX (US); Martin A. Perimutter, Houston, TX (US)

(72) Inventors: Michael Pyrcz, The Woodlands, TX (US); Martin A. Perimutter, Houston, TX (US)

(73) Assignee: Chevron U.S.A. Inc., San Ramon, CA (US)

(21) Appl. No.: 13/906,798

(22) Filed: May 31, 2013

(51) Int. Cl. G06F 17/18

(52) U.S. Cl. CPC G06F 17/18
USPC 702/2

(57) ABSTRACT

Geological systems are automatically categorized based on one or more characteristics. Datasets from one or more sources related to a space of a geological system are transformed, cropped and analyzed using lacunarity-based statistical methodologies. The one or more analyzed datasets describe characteristics of the transformed dataset within the space of the geological system. The characteristics of the distribution of the transformed dataset are compared with one or more characteristics of one or more previously categorized geological systems. The space within the geological system is categorized based upon an indication that the characteristics of the transformed data set of the space within the geological system is similar to the characteristics of one or more previously categorized geological systems.

### FIELD

The disclosure relates to characterizing and differentiating depositional geological systems wherein statistical methodologies are used to determine characteristic distributions within a geological system and comparing the distributions with previously processed geological systems to categorize the geological system.

### BACKGROUND

Previously, characterizing and categorizing geological systems has been predominantly performed using qualitative methodologies. Such qualitative methodologies include using geological data, engineering data, and human expertise to provide the best single model believed to be the best representation of the geological system. The qualitative methodologies expose the model to large and consequential inaccuracies. As a result model inaccuracies are manifold including those of interpreters and modelers owing to information gaps and lack of experience. The impact of selecting the model include wide divergence between model-based predictions and observed geological systems.

### SUMMARY

One aspect of the disclosure relates to a computer-implemented method for categorizing geological systems. The method may be implemented in a computer system that includes one or more physical processors. The method may include transforming one or more datasets of a space within a first geological system into a transformed dataset in accordance with one or more selected criterion; cropping the transformed dataset to provide a transformed dataset of the space within the first geological system having consistent heterogeneity; analyzing the lacunarity within the cropped transformed dataset to provide an analyzed dataset which describes characteristics of the distribution of the transformed dataset within the space of the geological system; comparing the characteristics of the distribution of the transformed dataset with one or more characteristics of one or more previously categorized geological systems; and, categorizing the space based upon an indication that the characteristics of the transformed data set of the space within the first geological system is similar to the characteristics of one or more previously categorized geological systems.

Another aspect of the disclosure relates to a system for categorizing geological systems, wherein the system comprises one or more processors configured to execute one or more computer program modules. The computer program modules may include a transformation module, a truncation module, a statistics module, a record module, an allocation module, an expert module, and/or other modules. The transformation module may be configured to transform one or more datasets of a space within a first geological system into a transformed dataset in accordance with one or more selected criterion. The truncation module may be configured to crop the transformed dataset to provide a transformed dataset of the space within the first geological system having consistent heterogeneity. The statistics module may be configured to analyze the lacunarity within the cropped transformed dataset to provide an analyzed dataset which describes characteristics of the distribution of the transformed dataset within the space. The record module may be configured to compare the characteristics of the distribution of the transformed dataset with one or more characteristics of one or more previously categorized geological systems. The allocation module may be configured to categorize the space based upon an indication that the characteristics of the transformed data set of the space within the first geological system is similar to the characteristics of one or more previously categorized geological systems. The expert module may be configured to facilitate review of the category assigned to the space, by the allocation module, within the first geological system using one or more experts.

Yet another aspect of the disclosure relates to a method for building a knowledge base of categorized geological systems. In some implementations, the method comprises transforming one or more datasets of a space within a first geological system into a transformed dataset in accordance with one or more selected criterion; cropping the transformed dataset to provide a transformed dataset of the space within the first geological system having consistent heterogeneity; analyzing the lacunarity within the cropped transformed dataset to provide an analyzed dataset which describes characteristics of the distribution of the transformed dataset within the space of the first geological system; repeating the previous steps for one or more data sets of a space within a second geological system; and grouping the first geological system and the second geological system in accordance with a metric based on the one or more characteristics of the distribution of the transformed datasets of the first geological system and the second geological system.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 is a method for categorizing geological systems.

FIG. 2 is a method for building a knowledge base of categorized geological systems.

FIG. 3 illustrates a system for categorizing geological systems.

### DETAILED DESCRIPTION

The present technology may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present technology may be coded in different languages for application in a variety of computing platforms and environments. It will be appreciated that the scope and underlying principles of the present technology are not limited to any particular computer software technology.

Moreover, those skilled in the art will appreciate that the present technology may be practiced using any one or combination of hardware and software configurations, including but not limited to a system having single and/or multi-processer computer processors system, hand-held devices, programmable consumer electronics, mini-computers, mainframe computers, and the like. The technology may also be practiced in distributed computing environments where tasks are performed by servers or other processing devices that are linked through one or more data communications networks. In a distributed computing environment, program modules may be located in both local and remote computer storage media including memory storage devices.

Also, an article of manufacture for use with a computer processor, such as a CD, pre-recorded disk or other equivalent devices, may include a computer program storage medium and program means recorded thereon for directing the computer processor to facilitate the implementation and practice of the present technology. Such devices and articles of manufacture also fall within the spirit and scope of the present technology.

Referring now to the drawings, embodiments of the present technology will be described. The technology can be implemented in numerous ways, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the present technology are discussed below. The appended drawings illustrate only typical embodiments of the present technology and therefore are not to be considered limiting of its scope and breadth.

One aspect of the disclosure relates to processing one or more datasets of spaces of geological systems by applying one or more statistical methodologies to the datasets to provide characteristic distributions within the space of the geological system. The space of the geological system may include the entire geological system or extend beyond the perimeter of the geological system, such as a river delta. The space of the geological system may include a subpart of the geological system, such as an individual lobe of the river delta. The space of the geological system may include a volume extending between, and overlapping and/or including, more than one geological system. The lacunarity within the one or more datasets may be analyzed to provide a description of the characteristic distribution of features within the space. The statistical description of the characteristic distribution of features within the space may be compared to previously categorized geological systems to provide a statistically determined indication of the categories of geological systems to which the space and/or associated geological system belongs. Providing a statistically determined indication of the category or categories to which a space within a geological system belongs provides a quantitative method for categorizing geological systems, reducing qualitative errors imparted into such determinations by previously used methods, and providing more robust categorizations.

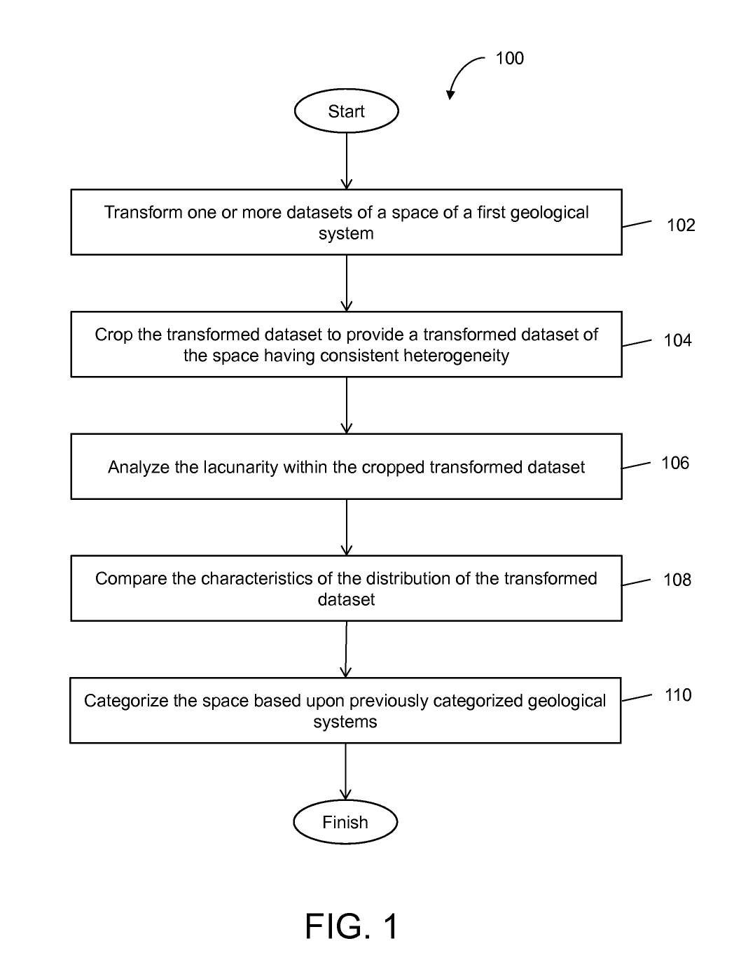

FIG. 1 illustrates a method 100 for categorizing geological systems. The operations of method 100 presented below is intended to be illustrative. In some implementations, method 100 may be accomplished with one or more additional operations not described, and/or without one or more of the operations discussed. Additionally, the order in which the operations of method 100 are illustrated in FIG. 1 and described herein is not intended to be limiting.

In some implementations, method 100 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 100 in response to instructions stored electronically on one or more electronic storage mediums. The one or more processing devices may include one or more devices configured through hardware, firmware, and/or software to be specifically designed for execution of one or more of the operations of method 100.

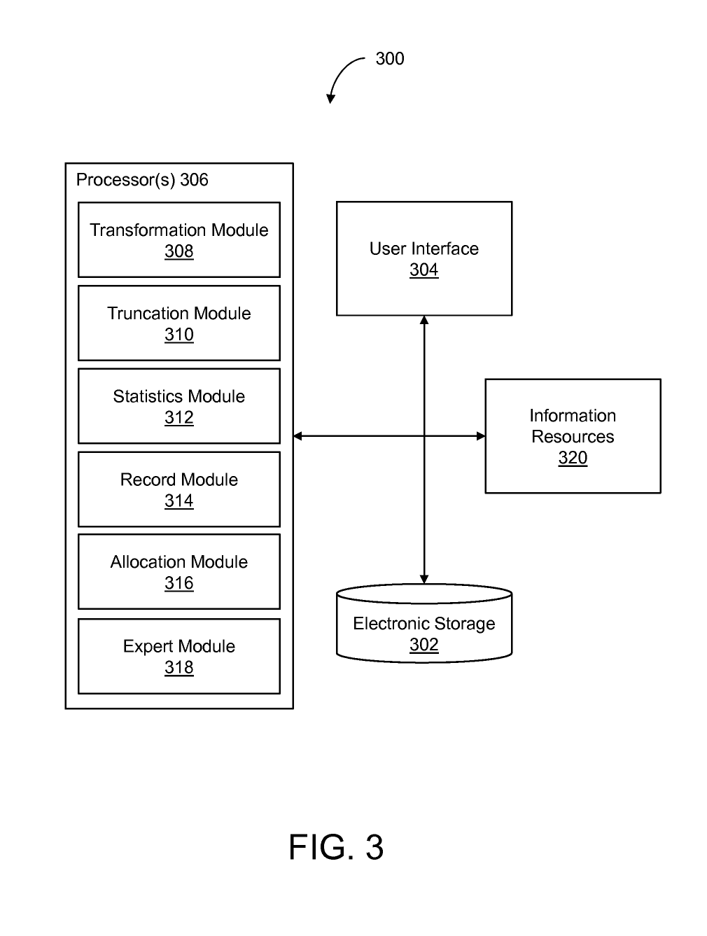

At an operation 102, one or more datasets of a space within a first geological system may be transformed to provide a transformed dataset in accordance with one or more selected criterion. In some implementations, operation 102 may be performed by a transformation module the same as or similar to transformation module 308 (shown in FIG. 3 and described herein).

Transforming the datasets may include digitizing analogue data representing the geological system, or space within the geological system, received from one or more sources. Transforming the datasets may include applying one or more statistical methodologies to the dataset to provide a transformed dataset suitable for further analysis. Sources of the datasets may include natural or synthetic datasets. Such natural and synthetic datasets may result from observations made from satellites, observations made from aircraft, observations made from ground level, seismic information, flume and/or experimental stratigraphy numerical process models, rule-based models, geostatistical models, and/or other sources.

The one or more criterion upon which the one or more datasets of the space are transformed may include criteria specific to a selected problem setting. For example, the method may include criterion for emphasizing specified features of the space. Such emphasized features may include distinct bodies within the geological system, thresholds between two geologically distinct regions within the system, edges of a geological system or portion of a geological system, transitions between two geologically distinct regions or portions of a geological region, specified azimuths, and/or other features within and/or of the geological system. Criterion may relate to geological system characteristic problems, such as reservoir flow or fluid recovery problems. Such criterion may relate to flow simulations, and any proxy for flow to group the one or more datasets by flow behavior. For other geological processes, the criterion may be related to the critical processes that define the geological process observed.

At an operation 104, the transformed dataset may be cropped. Cropping the transformed dataset may be performed to provide a transformed dataset of the space within the first geological system having consistent heterogeneity. Cropping the dataset may comprise trimming the dataset to remove non-heterogeneous populations from the dataset. Cropping the dataset may comprise selecting a portion of the dataset where the data is heterogeneous, avoiding other portions of the dataset where the dataset indicates that it relates to non-heterogeneous populations. Inconsistent heterogeneity in the dataset indicates that the dataset spans an area outside of the desired distinct geological system or feature being processed. Cropping the transformed dataset may include determining an area of the dataset where population distributions change beyond a specified deviation from the population distributions of other areas of the dataset. Cropping the transformed dataset may increase the statistical stationarity of the dataset related to the space within the geological system. Cropping the transformed dataset may be configured to remove large scale trends, significant transitions, and/or separate populations having a sufficiently different heterogeneity. In some implementations, operation 104 may be performed by a truncation module the same as or similar to truncation module 310 (shown in FIG. 3 and described herein).

At an operation 106, the lacunarity within the cropped transformed dataset may be analyzed to provide an analyzed dataset. At an operation 106, other spatial statistical methodologies may be applied to augment the lacunarity-based statistical methodologies to provide a further refined analyzed dataset. At an operation 106, the variability within the cropped transformed dataset may be analyzed to provide an analyzed dataset. The variability may be spatial variability where any spatial statistical methodologies may be applied to the cropped transformed dataset to provide statistically determined spatial characteristics of the space within the geological system. The analyzed dataset may statistically describe characteristics of the distribution of the transformed dataset within the space of the geological system. Analyzing the variability within the cropped transformed dataset may include applying one or more spatial statistical methodologies to provide a statistical sampling of the dataset. In some implementations, at an operation 106, analyzing the lacunarity within the transformed cropped dataset may be configured to provide a distance scale of the space within the first geological system, facilitating comparison with other geological systems of different size. In some implementations, operation 106 may be performed by a statistical module the same as or similar to statistical module 312 (shown in FIG. 3 and described herein).

The lacunarity-based statistical methodologies may include a three-dimensional window geometry applied to the transformed dataset, based at least in part on expected feature sizes present, data sampling density, and a size of the geological system, or space within the geological system, being observed. A discussion of one aspect of the contemplated lacunarity-based statistical methodology applied to the one or more datasets is discussed in U.S. application Ser. No. 12/633,630, filed Dec. 8, 2009, incorporated herein by reference.

The additional statistical methodologies may be configured to refine the determined characteristics of the space of the geological system. Statistical methodologies, herein contemplated, may include lacunarity analysis, probability density function, multiple-point statistics, Markov transitions, indicator function, n-point covariance, spatial cumulants, Ripley's K function, nearest neighbor analysis, variogram analysis, and/or other spatial statistical methodologies.

At an operation 108, the characteristics of the distribution of the transformed dataset may be compared with one or more characteristics of one or more previously categorized geological systems. Geological systems having a different size may be compared for similar or like characteristics wherein the dataset related to a first geological system and a second geological system, to which the first geological is compared, comprise a scale. In some implementations, operation 108 may be performed by a record module the same as or similar to record module 314 (shown in FIG. 3 and described herein).

At an operation 110, the space within the geological system may be categorized based upon an indication that the characteristics of the transformed data set of the space within the first geological system is similar to the characteristics of one or more previously categorized geological systems. Geological systems and/or spaces within geological systems may be categorized with geological systems having a different size where the geological systems have similar scaled characteristics. In some implementations, the space within the geological system may be sub-categorized based upon an indication that the space has one or more sub-characteristics. In some implementations, operation 110 may be performed by an allocation module the same as or similar to allocation module 316 (shown in FIG. 3 and described herein).

In some aspects, one or more population distributions across the analyzed data set may be observed at the operation 108. At the operation 108, the analyzed data set may be compared with previously categorized geological systems, based upon the one or more observed population distributions, observed at an operation 106. A distance scale of the space within the first geological system may be received at an operation 108, to compare the space with the previously categorized geological systems having the same or different size. Such distance scale may be provided by the one or more natural or synthetic datasets. Characteristics of the distribution of the scaled transformed dataset of the space within the first geological system may be compared with one or more characteristics of one or more previously categorized geological systems, wherein the one or more previously categorized geological systems have a different size than the first geological system. A population distribution of the geological space may be inferred at the operation 110, at scales different from the scale of the space, based on a comparison with previously categorized geological systems.

The method 100 may also include an operation wherein the category assigned to the space within the first geological system may be reviewed by one or more experts. In some implementations, such an operation may be performed by an expert module the same as or similar to expert module 318 (shown in FIG. 3 and described herein).

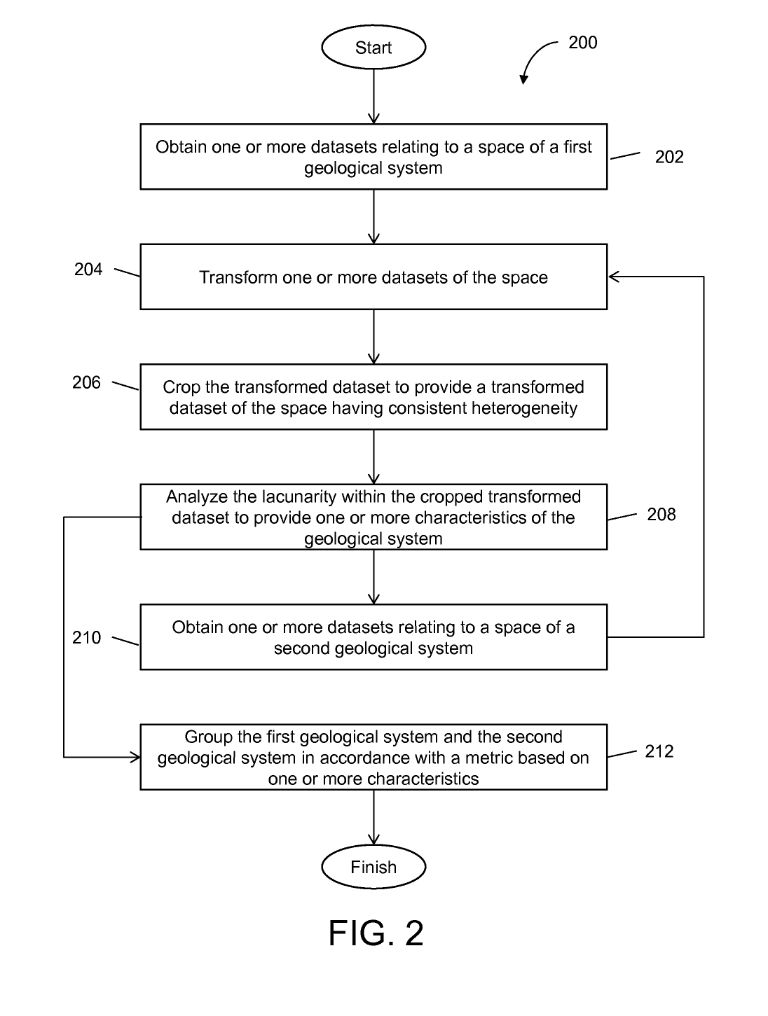

FIG. 2 illustrates a method 200 for building a knowledge base of categorized geological systems. The operations of method 200 presented below is intended to be illustrative. In some implementations, method 200 may be accomplished with one or more additional operations not described, and/or without one or more of the operations discussed. Additionally, the order in which the operations of method 200 are illustrated in FIG. 2 and described herein is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on one or more electronic storage mediums. The one or more processing devices may include one or more devices configured through hardware, firmware, and/or software to be specifically designed for execution of one or more of the operations of method 200.

At an operation 202, one or more datasets relating to a space of a first geological system may be obtained. Such natural and synthetic datasets may result from observations made by satellites, observations made from aircraft, observations made from ground level, observation at wells (such as core samples, well logs, production data, and/or other information observed at wells), seismic information, flume and/or experimental stratigraphy, numerical process models, rule-based models, geostatistical models, and/or other sources.

At an operation 204, the one or more datasets of a space within a first geological system may be transformed into a transformed dataset in accordance with one or more selected criterion. In some implementations, features of the space may be emphasized by transforming the one or more datasets. In some implementations, operation 204 may be performed by a transformation module, the same as or similar to transformation module 308 (shown in FIG. 3 and described herein).

At an operation 206, the transformed dataset may be cropped to provide a transformed dataset of the space within the geological system having consistent heterogeneity. In some implementations, operation 206 may be performed by a truncation module, the same as or similar to truncation module 310 (shown in FIG. 3 and described herein).

At an operation 208, the lacunarity within the cropped transformed dataset may be analyzed to provide an analyzed dataset which describes characteristics of the distribution of the transformed dataset within the space of the geological system. At an operation 208 one or more additional statistical methodologies may be applied to the cropped transformed data set. The additional statistical methodologies may refine the described characteristics of the distribution of the transformed dataset within the space of the geological system. At an operation 208, the variability within the cropped transformed dataset may be analyzed to provide an analyzed dataset which describes characteristics of the distribution of the transformed dataset within the space of the geological system. The variability may be analyzed using one or more spatial statistical methodologies. In some implementations, operation 208 may be performed by a statistics module, the same as or similar to statistics module 312 (shown in FIG. 3 and described herein).

At an operation 210, one or more datasets relating to a space of a second geological system may be obtained.

In response to obtaining the one or more datasets relating to a space of a second geological system, operations 204, 206, and 208 may be performed with the one or more datasets relating to the space of the second geological system, to provide one or more characteristics of the second geological system.

At an operation 212, the first geological system and the second geological system may be grouped in accordance with a metric. The metric may be based on the one or more characteristics of the distribution of the transformed datasets of the first geological system and the second geological system. The metric may be determined by a grouping algorithm using the one or more characteristics of the geological system to determine similarities and differences between the geological systems and categorize the geological systems accordingly. In some implementations, the first geological system and the second geological system may be grouped into sub-groups in accordance with the metric. Sub-groups of geological systems may comprise geological systems having one or more similar sub-categories.

The method 200 may include obtaining one or more datasets for a third geological system and performing operations 204, 206 and 208 with the one or more datasets for the third geological system. The method 200 may comprise receiving a distance scale of the space within the first geological system, second geological system and the third geological system. At an operation 212, the first geological system and the third geological system may be grouped together into one or more categories related to one or more characteristics common to the first geological system and the third geological system, based on the one or more characteristics of the distribution of the transformed datasets of the first geological system and the third geological system, wherein first geological system has a different size than the third geological system. Geological systems may have different sizes while having similar characteristics. Providing a scale for the geological systems allows the datasets to be scaled such that geological systems of different sizes may be compared and grouped together when they demonstrate similar scaled characteristics. For example, a tributary for a major river system may have datasets having similar characteristics to the scaled datasets of a major river system, having similar scaled flow rates.

The method 200 may further comprise reviewing the grouping of the first geological system and the second geological system by one or more experts. In some implementations, such an operation may be performed by an expert module, the same as or similar to expert module 318 (shown in FIG. 3 and described herein).

The operations of method 100 described herein and shown in FIG. 1, and the operations of method 200 described in FIG. 2 are intended to be illustrative. In some embodiments, one or more of methods 100 and/or 200 may be accomplished with one or more additional operations not described, and/or without one or more of the operations discussed. Additionally, the order in which the operations of methods 100 and/or 200 are illustrated in FIGS. 1 and 2 and described herein is not intended to be limiting.

In some embodiments, one or more of methods 100 and/or 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of methods 100 and/or 200 in response to instructions stored electronically on an electronic storage medium. The one or more processing devices may include one or more devices configured through hardware, firmware, and/or software to be specifically designed for execution of one or more of the operations of methods 100 and/or 200.

FIG. 3 illustrates a system 300 configured to categorize geological systems. In some implementations, system 300 is configured to implement one or more of methods 100 and/or 200 shown in FIGS. 1 and/or 2, respectively, and described herein. In one embodiment, system 300 includes electronic storage 302, a user interface 304, one or more processors 306, one or more information resources 320, and/or other components.

Electronic storage 302 may comprise electronic storage media that electronically stores information. The electronic storage media of electronic storage 302 may include one or both of system storage that is provided integrally (i.e., substantially non-removable) with system 300 and/or removable storage that is removably connectable to system 300 via, for example, a port (e.g., a USB port, a firewire port, etc.) or a drive (e.g., a disk drive, etc.). Electronic storage 302 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 302 may store software algorithms, information determined by processor 306, information received via user interface 304, information obtained from electronic storage 302, information obtained from one or more information resources 320, and/or other information that enables system 300 to function properly. Electronic storage 302 may be a separate component within system 300, or electronic storage 302 may be provided integrally with one or more other components of system 300 (e.g., processor 306) in a single device (or set of devices).

User interface 304 may be configured to provide an interface between system 300 and one or more users through which the user(s) may provide information to and receive information from system 300. This enables data, results, and/or instructions and any other communicable items, collectively referred to as “information,” to be communicated between the user(s) and one or more of electronic storage 302, information resources 320, and/or processor 306. Examples of interface devices suitable for inclusion in user interface 304 include a keypad, buttons, switches, a keyboard, knobs, levers, a display screen, a touch screen, speakers, a microphone, an indicator light, an audible alarm, and a printer. In some implementations, information resources 320 may be included in electronic storage 302, or may be separate from electronic storage 302 as shown.

It is to be understood that other communication techniques, either hard-wired or wireless, are also contemplated by the present invention as user interface 304. For example, the present invention contemplates that user interface 304 may be integrated with a removable storage interface provided by electronic storage 302. In this example, information may be loaded into system 300 from removable storage (e.g., a smart card, a flash drive, a removable disk, etc.) that enables the user(s) to customize the implementation of system 300. Other exemplary input devices and techniques adapted for use with system 300 as user interface 304 include, but are not limited to, an RS-232 port, RF link, an IR link, modem (telephone, cable or other). In one embodiment, user interface 304 may be provided on a computing platform in operative communication with a server performing some or all of the functionality attributed herein to system 300. In short, any technique for communicating information with system 300 is contemplated by the present invention as user interface 304.

The information resources 320 may include one or more sources of information related to the geological system of interest, the space within the geological system of interest, other geological systems, the process of analyzing the geological system of interest and/or the statistical methodologies for analyzing the geological system of interest or space of the geological system of interest. The information resources 320 may include a knowledge base comprising one or more geological systems and/or spaces of geological systems grouped into categories based upon one or more characteristics. Characteristics may include specified population distributions across the datasets related to geological systems, relationships between geological systems, environmental parameters related to one or more geological systems. The categories may include geological systems having characteristics that are included in one or more other categories, and/or geological systems having categories specific to individual categories. The characteristics and/or categories may be entered and/or modified by one or more users (e.g. via user interface 304), and/or categories and/or characteristics may be automatically determined (e.g. by processor(s) 306, or some other processor).

Processor(s) 306 may be configured to provide information processing capabilities in system 300. As such, processor(s) 306 may include one or more of a digital processor, an analog processor, a digital circuit designed to process information, an analog circuit designed to process information, a state machine, and/or other mechanisms for electronically processing information. Although processor(s) 306 is shown in FIG. 1 as a single entity, this is for illustrative purposes only. In some implementations, processor(s) 306 may include a plurality of processing units. These processing units may be physically located within the same device, or processor(s) 306 may represent processing functionality of a plurality of devices operating in coordination.

As is shown in FIG. 3, processor(s) 306 may be configured to execute one or more computer program modules. The one or more computer program modules may include one or more of a transformation module 308, a truncation module 310, a statistics module 312, a record module 314, an allocation module 316, an expert module 318, and/or other modules. Processor(s) 306 may be configured to execute modules 308, 310, 312, 314, 316, and/or 318 by software; hardware; firmware; some combination of software, hardware, and/or firmware; and/or other mechanisms for configuring processing capabilities on processor(s) 306.

It should be appreciated that although modules 308, 310, 312, 314, 316, and/or 318 are illustrated in FIG. 3 as being co-located within a single processing unit, in implementations in which processor(s) 306 includes multiple processing units, one or more of modules 308, 310, 312, 314, 316, and/or 318 may be located remotely from the other modules. The description of the functionality provided by the different modules 308, 310, 312, 314, 316, and/or 318 described below is for illustrative purposes, and is not intended to be limiting, as any of modules 308, 310, 312, 314, 316, and/or 318 may provide more or less functionality than is described. For example, one or more of modules 308, 310, 312, 314, 316, and/or 318 may be eliminated, and some or all of its functionality may be provided by other ones of modules 308, 310, 312, 314, 316, and/or 318. As another example, processor(s) 306 may be configured to execute one or more additional modules that may perform some or all of the functionality attributed below to one of modules 308, 310, 312, 314, 316, and/or 318. The one or more additional modules may provide additional and/or different functionality than modules 308, 310, 312, 314, 316, and/or 318, illustrated in FIG. 3 and described herein.

Transformation module 308 may be configured to transform one or more datasets of a space within a first geological system into a transformed dataset in accordance with one or more selected criterion. The transformation module 308 may be configured to provide a transformed dataset having emphasized features of the space within the first geological system. In some implementations, transforming the one or more datasets may include performing some or all of the functionality described above with respect to operation 102 (shown in FIG. 1 and described herein).

Truncation module 310 may be configured to crop the transformed dataset to provide a transformed dataset of the space within the first geological system having consistent heterogeneity. Truncation module 310 may be configured to crop the transformed dataset to provide a transformed dataset of the space within the first geological system having a desired level of heterogeneity. In some applications, it may be desired to have inconsistent heterogeneity, for example, where one or more characteristics of the geological system may be defined and/or determined by the desired level of heterogeneity. In some implementations, cropping the transformed dataset may include performing some or all of the functionality described above with respect to operation 104 (shown in FIG. 1 and described herein).

Statistics module 312 may be configured to analyze the lacunarity within the cropped transformed dataset to provide an analyzed dataset which describes characteristics of the distribution of the transformed dataset within the space. The statistics module 312 may be configured to analyze the variability within the cropped transformed dataset to provide an analyzed dataset which describes characteristics of the distribution of the transformed dataset within the space. Analyzing the variability may include applying one or more spatial statistical methodologies to the cropped transformed dataset to provide an analyzed dataset. One or more additional statistical methodologies may be applied to refine the analyzed dataset. In some implementations, analyzing the variability within the cropped transformed dataset may include performing some or all of the functionality described above with respect to operation 106 (shown in FIG. 1 and described herein).

In some implementations, the statistics module 312 may be configured to apply lacunarity-based statistical methodologies to the cropped transformed data set; wherein the lacunarity-based statistical methodologies provide a distance scale of the space within the first geological system, to provide an analyzed data set. The statistics module 312 may be configured to apply one or more additional statistical methodologies to the analyzed data set; wherein the additional statistical methodologies refine the distance scale of the space within the first geological system.

The record module 314 may be configured to compare the characteristics of the distribution of the transformed dataset with one or more characteristics of one or more previously categorized geological systems. The record module 314 may be configured to facilitate accessing an electronic knowledge base of geological systems. The electronic knowledge base may be stored in electronic storage 302. The electronic knowledge base may comprise groupings of geological systems, whereby the groupings are categorized based on one or more determined characteristics for the grouped geological systems. In some implementations, comparing the characteristics of the distribution of the transformed dataset may include performing some or all of the functionality described above with respect to operation 108 (shown in FIG. 1 and described herein).

The allocation module 316 may be configured to categorize the space of the geological system based upon an indication that the characteristics of the transformed data set of the space within the first geological system is similar to the characteristics of one or more previously categorized geological systems. In some implementations, this may include performing some or all of the functionality described above with respect to operation 110 (shown in FIG. 1 and described herein).

The record module 314 may be further configured to compare the characteristics of the distribution of the scaled transformed data set of the space within the first geological system with one or more characteristics of one or more previously categorized geological systems, wherein the one or more previously categorized geological systems has a different size than the first geological system.

The record module 314 may be configured to observe one or more population distributions across the analyzed data set and the allocation module 316 may be configured to categorize the analyzed data set based upon the one or more observed population distributions.

The expert module 318 may be configured to facilitate review of the category assigned to the space, by the allocation module 316, within the first geological system using one or more experts. The expert module 318 may be configured to facilitate display of the one or more categories assigned to the space of the geological system on the user interface 304. It is herein contemplated that the user interface 304 may include any form of user interface. The user interface 304 may include facilitating sending the information related to the geological system and the one or more assigned characteristics to the space of the geological system to one or more experts for review. For example, the expert module 318 may be configured to facilitate sending electronic mail to an expert containing the desired information for the expert to review the category assigned to the space within the geological system. The user interface 304 may include one or more screens and/or displays and one or more input devices to present to the expert desired information necessary for the expert to review the categories assigned to the space within the geological system, and to receive inputs, from the expert.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A method for categorizing geological systems comprising:
transforming one or more datasets of a space within a first geological system into a transformed dataset in accordance with one or more selected criterion;
cropping the transformed dataset to provide a transformed dataset of the space within the first geological system having consistent heterogeneity;
analyzing the lacunarity within the cropped transformed dataset to provide an analyzed dataset which describes characteristics of the distribution of the transformed dataset within the space;
comparing the characteristics of the distribution of the transformed dataset with one or more characteristics of one or more previously categorized geological systems; and,
categorizing the space based upon an indication that the characteristics of the transformed data set of the space within the first geological system are similar to the characteristics of one or more previously categorized geological systems.

2. The method of claim 1, further comprising applying one or more additional statistical methodologies to the analyzed data set; wherein the additional statistical methodologies refine the characteristics of the space within the first geological system.

3. The method of claim 1, further comprising:
observing one or more population distributions across the analyzed data set; and,
categorizing the analyzed data set based upon the one or more observed population distributions.

4. The method of claim 3, further comprising:
receiving a distance scale of the space within the first geological system, and,
inferring a population distribution of the geological space at scales different from the scale of the space, based on a comparison with previously categorized geological systems of different size.

5. The method of claim 1, further comprising:
receiving a distance scale of the space within the first geological system, and,
comparing the characteristics of the distribution of the scaled transformed dataset of the space within the first geological system with one or more characteristics of one or more previously categorized geological systems, wherein the one or more previously categorized geological systems have a different size than the first geological system.

6. The method of claim 1, wherein the step of transforming the one or more datasets of the space within the first geological system into a transformed dataset emphasizes features of the space.

7. The method of claim 1, further comprising reviewing the category assigned to the space within the first geological system using one or more experts.

8. A system for categorizing geological systems comprising:
one or more processors configured to execute computer program modules, the computer program modules comprising:
a transformation module configured to transform one or more datasets of a space within a first geological system into a transformed dataset in accordance with one or more selected criterion;
a truncation module configured to crop the transformed dataset to provide a transformed dataset of the space within the first geological system having consistent heterogeneity;
a statistics module configured to analyze the lacunarity within the cropped transformed dataset to provide an analyzed dataset which describes characteristics of the distribution of the transformed dataset within the space;
a record module configured to compare the characteristics of the distribution of the transformed dataset with one or more characteristics of one or more previously categorized geological systems; and,
an allocation module configured to categorize the space based upon an indication that the characteristics of the transformed data set of the space within the first geological system is similar to the characteristics of one or more previously categorized geological systems.

9. The system of claim 8, wherein the statistics module is further configured to apply one or more additional statistical methodologies to the analyzed data set; wherein the additional statistical methodologies refine the distance scale of the space within the first geological system.

10. The system of claim 8, wherein the record module is further configured to observe one or more population distributions across the analyzed data set, and, wherein the allocation module is further configured to categorize the analyzed data set based upon the one or more observed population distributions.

11. The system of claim 8, wherein the record module is further configured to compare the characteristics of the distribution of the scaled transformed data set of the space within the first geological system with one or more characteristics of one or more previously categorized geological systems, wherein the one or more previously categorized geological systems has a different size than the first geological system.

12. The system of claim 8, wherein the transformation module is further configured to provide a transformed data set having emphasized features of the space within the first geological system.

13. The system of claim 8, further comprising an expert module configured to facilitate review of the category assigned to the space, by the allocation module, within the first geological system using one or more experts.

14. A method for building a knowledge base of categorized geological systems comprising:
(a) transforming one or more datasets of a space within a first geological system into a transformed dataset in accordance with one or more selected criterion;
(b) cropping the transformed dataset to provide a transformed dataset of the space within the first geological system having consistent heterogeneity;
(c) analyzing the lacunarity within the cropped transformed dataset to provide an analyzed dataset which describes characteristics of the distribution of the transformed dataset within the space of the first geological system;
(d) repeating steps (a) through (c) for one or more data sets of a space within a second geological system; and
(e) grouping the first geological system and the second geological system in accordance with a metric based on the one or more characteristics of the distribution of the transformed datasets of the first geological system and the second geological system.

15. The method of claim 14, wherein step (c) further comprises applying one or more additional statistical methodologies to the cropped transformed data set; wherein the additional statistical methodologies refine the described characteristics of the distribution of the transformed dataset within the space of the first geological system.

16. The method of claim 15, further comprising:
(f) repeating steps (a) through (c) for one or more data sets of a space within a third geological system;
receiving a distance scale of the space within the first geological system, and the third geological system;
grouping the first geological system with the second geological system, based on one or more similar characteristics of the distribution of the transformed datasets of the first geological system and the third geological system, wherein first geological system has a different size than the third geological system.

17. The method of claim 14, wherein performance of step (a) emphasizes features of the space.

18. The method of claim 14 further comprising reviewing the grouping of the first geological system and the second geological system by one or more experts.

19. The method of claim 14, wherein the step (a) emphasizes features of the space.
